(19) United States
(12) Patent Application Publication
(10) Pub. No.: US 2004/0039090 A1
(43) Pub. Date: Feb. 26, 2004

(54) Flame-resistant molding compositions

(76) Inventors: Andreas Seidel, Dormagen (DE); Thomas Eckel, Dormagen (DE); Dieter Wittmann, Leverkusen (DE)

Correspondence Address: BAYER POLYMERS LLC, 100 BAYER ROAD, PITTSBURGH, PA, 15205, US

(21) Appl. No.: 10/627,182

(22) Filed: Jul. 25, 2003

(30) Foreign Application Priority Data
Jul. 29, 2002 (DE) 10234419.1

(51) Int. Cl. C08L 69/00; C08L 67/00

(52) U.S. Cl. 524/115; 524/121

(57) ABSTRACT

A thermoplastic molding composition that features improved properties is: disclosed. The composition contains A) aromatic polycarbonate and/or polyester carbonate, B) polyalkylene terephthalate, C) graft polymer, D) an oligomeric phosphorus compound of formula (I),

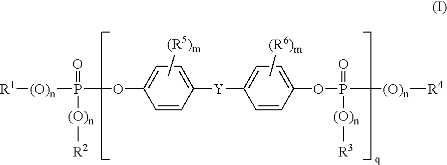

in which R¹, R², R³, R⁴ independently of each other mean C₁-C₈ alkyl, C₅-C₆-cycloalkyl, C₆-C₁₀-aryl or C₇-C₁₂ aralkyl, n independently of each other mean 0 or 1, q means 0.5 to, 15, and optionally E) fluorinated polyolefin,

### FIELD OF THE INVENTION

The invention relates to thermoplastic molding compositions and more particularly to flame-resistant polycarbonate molding compositions.

### SUMMARY OF THE INVENTION

A thermoplastic molding composition that features improved properties is disclosed. The composition contains A) aromatic polycarbonate and/or polyester carbonate, B) polyalkylene terephthalate, C) graft polymer, D) an oligomeric phosphorus compound of formula (I),

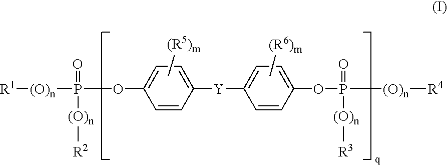

in which R¹, R², R³, R⁴ independently of each other mean C₁-C alkyl C₅-C₆-cycloalkyl, C₆-C₁₀-aryl or C₇-C₁₂ aralkyl, n independently of each other mean 0 or 1, q means 0.5 to 15, and optionally E) fluorinated polyolefin.

### BACKGROUND OF THE INVENTION

U.S. Pat. No. 5,030,675 discloses flame-resistant thermoplastic molding compositions of aromatic polycarbonate, ABS-polymer, polyalkylene terephthalate and also mono-phosphates and fluorinated polyolefins as flame-proofing additives. The molding compositions have, in particular, a high weld line strength, but have a greater tendency to form stress cracks at higher processing temperatures as a result of the action of chemicals.

EP-A 0363 608 discloses polymer mixtures of aromatic polycarbonate, styrene-containing copolymer and/or graft copolymer and also oligomeric phosphates and fluorinated polyolefins as flame-proofing additives. The level of weld line strength of these mixtures is often inadequate to produce complex thin-wall housing components, which generally have a large number of weld lines.

EP-A 0 594 021 discloses polymer mixtures of aromatic polycarbonate, polyalkylene terephthalate, graft polymer and resorcinol-bridged oligomeric phosphoric acid esters and fluorinated polyolefins as flame-proofing additives. Molded parts made from these molding compositions, which were produced at low processing temperatures, have a high resistance to stress cracking. Molded articles produced from these mixtures also have a high notched impact strength and surface quality. However, at higher processing temperatures, as are often required for the production of thin-wall components in particular, experience has shown that these molding compositions frequently have stress cracking problems. Here, the drastic reduction of the ESC properties as the processing temperature increases is probably a result of polymer decomposition processes and/or transesterification reactions between the polycarbonate and polyester.

The object of the present invention is to provide flame-resistant compositions with good thermal stability, which may be processed at high processing temperatures of up to 300° C. to thin-wall molded parts with improved mechanical properties, in particular higher resistance to stress cracking failure as a result of the action of chemicals, and which are also characterised by a combination of high weld line strength and elongation at break.

### DETAILED DESCRIPTION OF THE INVENTION

It has now been found, that polycarbonate/ABS compositions containing polyalkylene terephthalate with an oligomeric phosphoric acid ester based on bisphenol A as a flame-proofing additive have the desired profile of properties. These molding compositions are particularly suitable for the production of thin-wall housing components for data technology applications, where high processing temperatures and pressures place a considerable load on the material used, even during processing.

Even at processing temperatures of 300° C., molded parts made from the compositions according to the invention have excellent resistance to stress cracking failure as a result of the action of chemicals. The molding compositions also have significantly better weld line strength than flame-proofed PC/ABS molding compositions with comparable processing characteristics (i.e. melt flow capacity).

The invention provides flame-resistant thermoplastic molding compositions comprising

A) 40 to 95 parts by weight, preferably 50 to 90 parts by weight, particularly preferably 55 to 85 parts by weight, in particular 60 to 80 parts by weight of an aromatic polycarbonate and/or polyester carbonate,

B) 0.5 to 30 parts by weight, preferably 1 to 20 parts by weight, particularly preferably 2 to 15 parts by weight, in particular 3 to 10 parts by weight of a polyalkylene terephthalate,

C) 0.5 to 30 parts by weight, preferably 1 to 20 parts by weight, particularly preferably 2 to 15 parts by weight, in particular 3 to 12 parts by weight of a graft polymer,

D) 0.5 to 25 parts by weight, preferably 1 to 20 parts by weight, particularly preferably 2 to 18 parts by weight, in particular 5 to 15 parts by weight of an oligomeric phosphorus compound of formula (I),

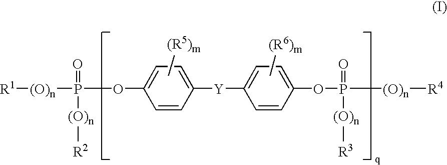

in which

R¹, R², R³, R⁴ independently, of each other mean C₁-C₈ alkyl, C₅-C₆ cycloalkyl, C₆—: or C₇-C₁₂ aralkyl radicals,

n independently of each other mean 0 or 1 preferably 1

q means 0.5 to 15, preferably 0.8 to 10, particularly preferably 1 to 5, in articular 1 to 2,

R⁵ and R⁶ independently of each other mean C₁-C₄ alkyl, in particular methyl

m independently of each other mean 0, 1, 2, 3 or 4 and

Y means C₁ to C₇ alkylidene, C_{1-C}₇ alkylene, C₅ to C₁₂ cycloalkylene, C₅ to C₁₂ cycloalkylidene radicals, —O—, —S—, —SO₂ or —O—, preferably isopropylidene or methylene radicals and

E) means 0 to 1 parts by weight preferably 0.1 to 1 parts by weight, particularly preferably 0.1 to 0.5 parts by weight, in particular 0.2 to 0.5 parts by weight of a fluorinated polyolefin.

The sum of all of the parts by weight A+B+C+D+E is 100.

Component A

The composition according to the invention contains polycarbonate and/or polyester carbonate, preferably aromatic polycarbonate and/or polyester, carbonate. Aromatic polycarbonates and/or aromatic polycarbonates according to component A, which are suitable according to the invention, are known from the literature or may be produced by processes known from the literature such as interfacial or melt polymerization processes (for the production of aromatic polycarbonates see for example Schnell, “Chemistry and Physics of Polycarbonates”, Interscience Publishers, 1964 and DE-AS 1 495 626, DE-A 2 232 877, DE-A 2 703 376, DE-A 2 714 544, DE-A 3 000 610, DE-A 3 832 396; for the production of aromatic polyestercarbonates, e.g. DE-A 3 077 934).

Aromatic polycarbonates are produced e.g. by reaction of aromatic dihydroxy compounds preferably diphenols with carbonic acid halides, preferably phosgene, and/or with aromatic dicarboxylic acid dihalogenides, preferably benzene; dicarboxylic acid dihalogenides, by the interfacial process, optionally using chain stoppers, for example monophenols, and optionally using trifunctional or more than trifunctional branching agents, for example triphenols or tetraphenols.

Diphenols for the production of the aromatic polycarbonates and/or aromatic polyester carbonates are preferably those of formula (II)

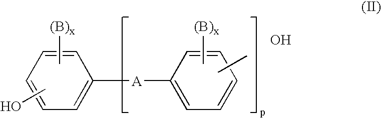

wherein

A may be a single bond, C₁ to C₅ alkylene, C₂ to C₅ alkylidene, C₅ to C₆ cycloalkylidene, —O—, —SO—, —CO—, —S—, —SO₂—, C₆ to C₁₂ arylene, to which other aromatic rings, optionally containing heteroatoms, may be condensed;

or a group of formula (III) or (IV)

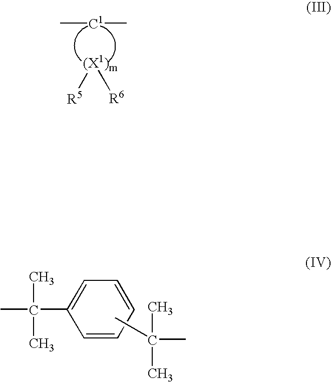

B means, in each case, C₁ to C₁₂ alkyl, preferably methyl,

x means, in each case, independently of each other 0, 1 or 2,

p means 1 or 0 and

R⁵ and R⁶ mean, independently of each other, hydrogen or C₁ to C₆ alkyl, preferably hydrogen methyl or ethyl, individually selected for each X¹,

X¹ means carbon and

m means a whole number from 4 to 7, preferably 4 or 5, provided that R⁵ and R⁶ are simultaneously alkyl on at least one X¹atom.

Preferred aromatic dihydroxy compounds are hydroquinone, resorcinol, dihydroxydiphenols, bis-(hydroxyphenyl)-C₁-C₅-alkanes, bis-(hydroxyphenyl)-C₅-C₆-cycloalkanes, bis-(hydroxyphenyl)-ethers, bis-(hydroxyphenyl)-sulfoxides, bis-(hydroxyphenyl)-ketones, bis-(hydroxyphenyl)-sulfones and α,α-bis-(hydroxyphenyl)-diisopropyl-benzenes.

Particularly preferred diphenols are 4,4′-dihydroxydiphenyl, bisphenol A, 2,4-bis(4-hydroxyphenyl)-2-methylbutane, 1,1-bis-(4-hydroxyphenyl)-cyclohexane, 1,1-bis-(4-hydroxyphenyl)-3.3.5-trimethylcyclohexane, 4,4′-dihydroxydiphenyl sulfide and 4,4′-dihydroxydiphenyl sulfone. 2,2-bis-(4-hydroxyphenyl)-propane (bisphenol A) is preferred particular.

The diphenols may be used alone or as mixtures of any kind. The diphenols are known from the literature, or may be obtained by processes known from the literature.

Chain stoppers suitable for the production of the thermoplastic aromatic poly-carbonates are for example phenol, p-tert.-butylphenol, and also long-chain alkyl phenols, such as 4-(1,3-tetramethylbutyl)-phenol according to DE-A2 842 005 or monoalkylphenol or dialkylphenols with a total of 8 to 20 carbon atoms in the alkyl substituents, such as 3,5-di-tert.-butylphenol, p-iso-octylphenol, p-tert.-octyphenol, p-dodecylphenol and 2-(3,5-dimethylheptyl)-phenol and 4-(3,5-dimethylheptyl)-phenol. The quantity of chain stoppers to be used is generally 0.5 mol. % to 10 mol. % in relation to the molar sum of the diphenols used in each case.

The thermoplastic, aromatic poly(ester)carbonates have weight average molecular weights (M_{w}, measured e.g. by ultracentrifuge, light scattering or gel permeation chromatography) of 10,000 to 200,000, preferably 15,000 to 80,000, particularly preferably 17,000 to 40,000, in particular 18,000 to 35,000.

The thermoplastic, aromatic, polycarbonates may be branched in the known way, preferably by incorporating 0.05 to 2.0 mol. % in relation to the total diphenols used, of trifunctional or more than trifunctional compounds, for example those with three or more phenolic groups.

Both homopolycarbonates and copolycarbonates are suitable. Copolycarbonates according to component A prepared of 1 to 25 wt. %, preferably 2.5 to 25 wt. %, in relation to the total quantity of diphenols to be used, of polydiorganosiloxanes with hydroxyaryloxy terminal groups may also be used. These are known (U.S. Pat. No. 3,419,634 incorporated herein by reference) and may be produced by processes known from the literature. The production of polydiorganosloxane-containing copolycarbonates is disclosed in DE-A 3 334 782.

Preferred polycarbonates are, in addition to bisphenol A homopolycarbonates, copolycarbonates of bisphenol A containing up to 15 mol. % in relation to the molar sums of diphenols, of diphenols other than those stated as preferred or preferred in particular.

Aromatic dicarboxylic acid dihalogenides for the production of aromatic polyester carbonates are preferably the diacid dichlorides of isophthalic acid, terephthalic acid, diphenylether-4,4′-dicarboxylic acid and naphthaline-2,6-dicarboxylic acid.

Mixtures of the diacid dichloride of isophthalic acid and terephthalic acid in a ratio of 1:20 to 20:1 are preferred in particular.

A carbonic acid halide, preferably phosgene, is also used as a bifunctional acid derivative in the production of polyester carbonates.

In addition to the monophenols mentioned already, their chlorocarbonic acid esters and acid chlorides of aromatic monocarboxylic acids, which may optionally be substituted by C₁ to C₂₂ alkyl groups, as well as aliphatic C₂ to C₂₂ monocarboxylic acid chlorides, are also possible chain stoppers for the production of aromatic polyester carbonates.

The quantity of chain stoppers is 0.1 to 10 mol. % in each case, in relation to mol diphenol, in the case of phenolic chain stoppers, and to mol dicarboxylic acid dichloride in the case of monocarboxylic acid chloride chain stoppers.

The aromatic polyester carbonates may also incorporate aromatic hydroxy-carboxylic acids.

The aromatic polyester carbonates may be both linear and branched in the known way (see DE-A 2 940 024 and DE-A 3 007 934 on this subject).

Tri- or polyfunctional carboxylic acid chlorides, such as trimesic acid trichloride, cyanuric acid trichloride, 3,3′-,4,4′-benzophenone tetracarboxylic acid tetra-chloride, 1,4,5,8-naphthaline tetracarboxylic acid tetrachloride or pyromellitic acid tetrachloride, in quantities of 0.01 to 1.0 mol. % (in relation to the dicarboxylic acid dichlorides used) or tri- or polyfunctional phenols, such as phloroglucinol, 4,6-dimethyl-2,4,6-tri-(4-hydroxyphenyl)-heptene-2,4,6-dimethyl-2,4-6-tri-(4-hydroxyphenyl)-heptane, 1,3,5-tri-(4-hydroxyphenyl)-benzene, 1,1,1-tri-(4-hydroxyphenyl)-ethane, tri-(4-hydroxyphenyl)-phenylmethane, 2,2-bis[4,4-bis(4-hydroxy-phenyl)-cyclohexyl]-propane, 2,4-bis(4-hydroxyphenyl-isopropyl)-phenol, tetra-(4-hydroxyphenyl)-methane, 2,6-bis(2-hydroxy-5-methyl-benzyl)-4-methyl-phenol, 2-(4-hydroxyphenyl)-2-(2,4-dihydroxyphenyl)-propane, tetra-(4[4-phenyl-isopropyl]-phenoxy)-methane, 1,4-bis[4,4′-dihydroxytri-phenyl-methyl]-benzene, in quantities of 0.01 to 1.0 mol. % in relation to the diphenols used, for example, may be used as branching agents. Phenolic branching agents may be added with the diphenols, acid chloride branching agents may be introduced together with the acid dichlorides.

The proportion of carbonate structural units in the thermoplastic, aromatic polyester carbonates may be varied at will. The proportion of carbonate groups is preferably up to 100 mol. %, in particular up to 80 mol. %, particularly preferably up to 50 mol. % in relation to the sum of ester groups and carbonate groups. Both the ester and carbonate content of the aromatic polyester carbonates may be present in the form of blocks or distributed statistically in the polycondensate.

The thermoplastic, aromatic polycarbonates and polyester carbonates may be used alone or in any mixture.

Component B

The polyalkylene terephthalates of component B are reaction products of aromatic dicarboxylic acids or their reactive derivatives, such as dim ethyl esters or anhydrides, and aliphatic, cycloaliphatic or araliphatic diols, as well as mixtures of these reaction products.

Preferred polyalkylene terephthalates contain at least 80 wt. %, preferably at least 90 wt. % in relation to the dicarboxylic acid component, of terephthalic acid groups and at least 80 wt. %, preferably at least 90 mol. %, in relation to the diol component, of ethylene glycol- and/or butane diol-1,4-groups.

The preferred polyalkylene terephthalates may contain, in addition to terephthalic acid esters, up to 20 mol. %, preferably up to 10 mol. %, groups of other aromatic or cycloaliphatic dicarboxylic acids containing 8 to 14 C atoms or aliphatic dicarboxylic acids containing 4 to 12 C atoms, such as groups of phthalic acid, isophthalic acid, naphthalene-2,6-dicarboxylic acid, 4,4′-diphenyl dicarboxylic acid, succinic acid, adipic acid, sebacic acid, azelaic acid, cyclohexanediacetic acid.

The preferred polyalkyene terephthalates may contain, in addition to ethylene glycol- or butane diol-1,4-groups, up to 20 mol. %, preferably up to 10 mol. %, other aliphatic diols containing 3 to 12 C atoms or cycloaliphatic diols containing 6 to 21 C atoms, e.g. groups of propanediol-1,3,2-ethylpropanediol-1,3, neopentylglycol, pentanediol-1,5, hexanediol-1,6, cyclohexane-dimethanol-1,4,3-ethylpentanediol-2,4,2-methylpentanediol-2,4 2,2,4-trimethylpentanediol-1,3,2-ethylhexanediol-1,3,2,2-diethylpropanediol-1,3, hexanediol-2,5,1,4-di-(β-hydroxyethoxy)-benzene, 2,2-bis-(4-hydroxycyclohexyl)-propane, 2,4-dihydroxy-1,1,3,3-tetramethyl-cyclobutane, 2,2-bis-(4-β-hydroxyethoxy-phenyl)-propane and 2,2-bis-(4-hydroxypropoxy-phenyl)-propane (DE-A 2 407, 674, 2 407 776, 2 715 932).

The polyalkylene terephthalates may be branched by building relatively small quantities of tri- or tetravalent alcohols or 3- or 4-basic carboxylic acids, e.g according to DE-A 1 900 270 and U.S. Pat. No. 3,692,744. Examples of preferred branching agents are trimesic acid, trimellitic acid, trimethyloethane and propane and pentaerythritol.

Polyalkylene terephthalates, which are produced only from terephthalic acid and its reactive derivatives (e.g its dialkyl esters) and ethylene glycol and/or butane diol-1,4, and mixtures of these polyalkylene terephthalates, are preferred in particular.

Preferred mixtures of polyalkylene terephthalates contain 0 to 50, wt. %, preferably, 0 to 30 wt. % polybutylene terephthalate and 50 to 100 wt. %, preferably 70 to 100 wt. % polyethylene terephthalate.

Pure polyethylene terephthalate is preferred in particular.

Polyalkylene terephthalates with a high tendency to crystallisation are preferred in particular. They are characterised in that the isothermic crystallisation time determined by the method given in the example section, is preferably <20 min, particularly preferably <10 min, in particular <7 min.

The polyalkylene terephthalates preferably used generally have an intrinsic viscosity of 0.4 to 1.5 cm³/g, preferably 0.5 to 1.2 cm³/g, measured in phenol/o-dichlorobenzene (1:1 parts by weight) at 25° C. in an Ubbelohde viscometer.

The polyalkylene terephthalates may be produced by the known methods (e.g. Kunststoff-Handbuch, Volume VIII, p. 695 ff., Carl-Hanser-Verlag, Munich 1973).

Component C

The composition according to the invention preferably contains one or more graft polymers of

C.1 5 to 95 wt. %, preferably 10 to 90 wt. %, in particular 20 to 50 wt. % of at least one vinyl monomer on

C.2 95 to 5 wt. %, preferably 90 to 10 wt. % in particular 80 to 50 wt. % of one or more elastomeric grafting bases with glass transition temperatures of <10° C., preferably <0° C., particularly preferably <−20° C., in particular <−40° C.

as impact strength modifier C.

The grafting base C.2 generally has a mean particle size (d₅₀ value) of 0.05 to 10 μm, preferably 0.1 to 5 μm, particularly preferably 0.1 to 1 μm in particular 0.2 to 0.5 μm.

Monomers C.1 are preferably mixtures of

C.1.1 50 to 99 wt. % vinyl aromatics and/or core-substituted vinyl aromatics (such as for example styrene, α-methylstyrene, p-methylstyrene, p-chlorostyrene) and/or methacrylic acid-(C₁-C₈)-alkylesters (such as methyl methacrylate, ethyl methacrylate) and C.1.2 1 to 50 wt. % vinyl cyanides (unsaturated nitriles such as acrylnitrile and methacrylonitrile) and/or (meth)acrylic acid-(C₁-C₈)-alkyl ester (such as methylmethacrylate, n-butylacrylate, tert.-butylacrylate) and/or derivatives (such as anhydrides and imides) of unsaturated carboxylic acids (for example maleic acid anhydride and N-phenyl-maleic imide).

Preferred monomers C.1.1 are selected from at least one of the monomers styrene, α-methylstyrene and methylmethacrylate, preferred monomers C.1.2 are selected from at least one of the monomers acrylonitrile, maleic acid anhydride and methylmethacrylate.

Monomers preferred in particular are C.1.1 styrene and C.1.2 acrylonitrile.

Grafting bases C.2. suitable for the graft polymers C are for example, diene rubbers, EP(D)M rubbers i.e. those based on ethylene/propylene and optionally diene, acrylate-, polyurethane-, silicon-, chloroprene- and ethylene/vinylacetate rubbers. Composites of different rubbers from this list are also suitable as a grafting base.

Preferred grafting bases C.2 are diene rubbers (e.g. based on butadiene, isoprene) or mixtures of diene rubbers or copolymers of diene rubbers or mixtures thereof with other copolymerizable monomers (e.g. according to C.1.1 and C.1.2), provided that the glass transition temperature of the component C.2 is <10° C., preferably <0° C., particularly preferably <−20° C., in particular <−40° C. Pure polybutadiene rubber is preferred in particular.

Particularly preferred polymers C are e.g. ABS polymers (emulsion-, composition- and suspension ABS), such as those disclosed e.g. in DE-A 2 035 390 (=U.S. Pat. No. 3,644,574) or in DE-A 2 248 242 (=GB-PS 1 409 275) or in Ullmanns, Enzyklopädie der Technischen Chemie, Vol. 19 (1980), p. 280 ff. The gel content of the-grafting base B.2 is at least 30 wt. %, preferably at least 40 wt. % (measured in toluene).

The graft copolymers C are produced by radical polymerization, e.g. by emulsion-, suspension-, solution-, or bulk polymerization, preferably by emulsion polymerization.

Particularly suitable graft rubbers are also ABS polymers, which are produced by redox initiation with an initiator system of organic hydroperoxide and ascorbic acid according to U.S. Pat. No. 4,937,285.

As it is known that the graft monomers are not necessarily fully grafted onto the grafting base during the grafting reaction, graft polymers B according to the invention are understood also to mean the products obtained, and those arising during processing, by (co)polymerization of the graft monomers in the presence of the grafting bases.

Suitable acrylate rubbers according to C.2 of polymer C are preferably polymers of acrylic acid alkyl esters, optionally containing up to 40 wt. % in relation to C.2. of other polymerizable, ethylenically unsaturated monomers. The preferred polymerizable acrylic acid esters include C₁ to C₈ alkyl esters, preferably methyl-, ethyl-, butyl-, n-octyl- and 2-ethylhexyl esters and mixtures of these monomers.

Monomers with more than one polymerizable double bond may be copolymerized for crosslinking. Preferred examples of crosslinking monomers are esters of unsaturated monocarboxylic acids with 3 to 8 C atoms and unsaturated monovalent alcohols with 3 to 2 C atoms, or saturated polyols with 2 to 4 OH groups and 2 to 20 C atoms, such as ethylene glycol dimethacrylate allylmethacrylate; polyunsaturated heterocyclic compounds, such as trivinyl- and triallyloyanurate; polyfunctional vinylcompounds, such as di- and trivinyl benzenes; but also triallylphosphate and diallylphthalate.

Preferred crosslinking monomers are allylnmethacrylate, ethylene glycol dimethacrylate, diallylphthalate and heterocyclic compounds, which have at least three ethylenically unsaturated groups.

Particularly preferred crosslinking monomers are the cyclicmonomers triallyl cyanurate, triallyl isocyanurate, triacryloyl hexahydro-s-triazine, triallyl benzenes. The crosslinked monomers preferably amount to 0.02 to 5, in particular 0.05 to 2 wt. % in relation to grafting base C.2.

With cyclically crosslinking monomers with at least three ethylenically unsaturated groups, it is advantageous to restrict the-quantity to less than 1 wt. % of the grafting base C.2.

Preferred “other” polymerizable, ethylenically unsaturated monomers, which may optionally be used in addition to the acrylic acid esters to produce the grafting base C.2, are e.g. acrylonitrile, styrene, α-methylstyrene, acrylamide, vinyl-C₁-C₆-alkylether, methylmethacrylate, butadiene. Acrylate rubbers preferred as grafting base C.2 are emulsion polymers, which have a gel content of at least 60 wt. %.

Other suitable grafting bases according to C.2 are silicon rubbers with graft-active site's, such as those disclosed in DE-A 3 704 657, DE-A 3 704 655, DE-A 3 631 540 and DE-A3631 539.

The gel content of grafting base C.2 is determined in a suitable solvent at 25° C. (M. Hoffmann, H. Krömer, R. Kuhn, Polymeranalytik I und II, Georg Thieme-Verlag, Stuttgart 1977).

The mean particle size d₅₀ is the diameter, above and below which 50 wt. % in each case of the particles lie. It may be measured by ultracentrifugation (W. Scholtan, H.Lange, Kolloid, Z. und Z. Polymere 250 (1972), 782-1796).

Component D

The compositions according to-the invention contain, as flame-proofing-agent, oligomeric phosphoric acid esters of general formula (I)

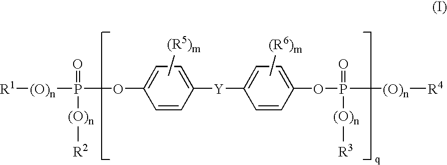

in which R⁵, R⁶, Y and m have the meanings given above.

R¹, R²′, R³ and R⁴ independently of each other, preferably represent C₁ to C₄ alkyl, phenyl, naphthyl or phenyl-C₁-C₄ alkyl. The aromatic groups R², R³ and R⁴ may themselves be substituted with alkyl groups, preferably C₁ to C₄ alkyl. Particularly preferred aryl groups are cresyl, phenyl, xylenyl, propylphenyl or butylphenyl.

n in formula (I) may, independently of each other, be 0 or 1, n is preferably equal to 1.

q represents values of 0.5 to 12, preferably 0.8 to 10, particularly preferably 1 to 5, in particular 1 to 2.

Compounds of the Structure

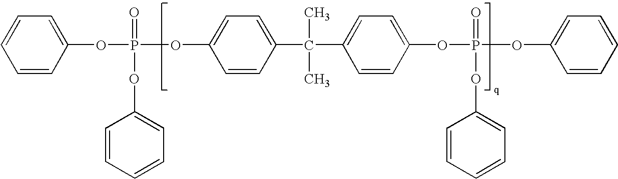

in which q is 1 to 2 are preferred in particular as component D.

The phosphorus compounds according to component D are known (cf. e.g. EP-A 0 363 608, EP-A 0 640 655) or may be: produced in the same way by known methods (e.g. Ullmanns Enzyklopädie der technischen Chemie, Vol. 18, p. 301 ff. 1979; Houben-Weyl, Methoden der organischen Chemie, Vol. 12/1, p. 43; Beilstein Vol. 6 p. 177).

The mean q values may be determined by determining the composition of the phosphate mixture (molecular weight distribution) by a suitable method (gas chromatography (GC), High Pressure Liquid Chromatography (HPLC), gel permeation chromatography (GPC)) and calculating the mean values for q on the, basis of this.

Component E

The flame-proofing agents according to component D are used in combination with anti-dripping agents, which reduce the tendency of the material to burning drip-off during a fire. Compounds of the substance-classes fluorinated polyolefins, silicons and aramide fibres are examples of these. They may also be used in the compositions according to the invention. Fluorinated polyolefins are preferred as anti-dripping agents.

Fluorinated polyolefins are known and disclosed for example in EP-A 0640655. They are marketed for example as Teflon® 30 N by DuPont.

The fluorinated polyolefins may be used both in their pure form and in the form of a coagulated mixture of emulsions of fluorinated polyolefins with emulsions of the graft polymers (component C) or with an emulsion of a copolymer, preferably based on styrene/acrylonitrile, the fluorinated polyolefin being mixed as an emulsion with an emulsion of the graft polymer or copolymer and then coagulated.

The fluorinated polyolefins may also be used as a pre-compound with he graft polymer (component C) or a copolymer, preferably based on styrene/acrylonitrile. The fluorinated polyolefins are mixed as a powder with a powder or granulate of the graft polymer or copolymer and compounded in the melt, generally at temperatures of 200 to 330° C. in conventional-machinery such as internal kneaders, extruders or double shaft screws.

The fluorinated polyolefins may also be used as a master batch, which is produced by emulsion polymerization of at least one monoethylenically unsaturated monomer in the presence of an aqueous dispersion of the fluorinated polyolefin. Preferred monomer components are styrene, acrylonitrile and mixtures thereof. After acid precipitation followed by drying, the polymer is used as a flowable powder.

The coagulates, pre-compounds or master batches generally contain 5 to 95 wt. %, preferably 7 to 60 wt. % fluorinated polyolefin.

The quantity of fluorinated polyolefins is given in relation to the absolute quantity of fluorinated polyolefin.

Other Additives

The compositions according to the invention may also contain up to 10 parts by weight, preferably 0.1 to 5 parts by weight, of one or more conventional polymer additive, such as a lubricant or mold release agent, for example pentacrythritol tetrastearate, a nucleation agent, an anti-static, a stabiliser, a light protection agent, a filling and reinforcing agent, a dye or pigment and a further flame-proofing agent or flame-proofing synergist, for example an inorganic substance in particulate nanoscale-form, and/or a silicate material such as talc or wollastonite.

The compositions according to the invention are produced by mixing the relevant components in the known way and melt compounding and melt extruding them at temperatures of 200° C. to 300° C. in conventional machinery such as internal kneaders, extruders and double shaft screws.

The individual components may be mixed in the known way both successively and simultaneously, and both at 20° C. (room temperature) and at a higher temperature.

The compositions according to the invention may be used to produce molded, articles of any kind. These may be produced, for example, by injection molding, extrusion and blowing. Another processing method is the production of molded articles by deep drawing from previously-produced sheets or films.

Examples of such molded articles are films, profiles, housing components of all kinds, e.g. for domestic appliances such as juice extractors, coffee machines, food mixers; for office machinery such as monitors, printers, copiers; additionally sheets, tubes, electrical installation ducts, profiles for the building industry, internal renovation and external applications; components from the electrical industry such as switches and plugs and internal and external components for automobiles.

The compositions according to the invention may be used in particular for example to produce the following molded articles and molded parts:

Internal construction components for rail vehicles, ships, aircraft, buses and automobiles, hub caps, housings for electrical equipment containing small transformers, housings for devices for disseminating and transmitting information, housings and linings for medical purposes, massage devices and housings for massage devices, toy vehicles for children, sheet wall elements, housings for safety devices, rear spoilers, bodywork parts for motor vehicles, heat-insulated transport containers, devices for holding and caring for small animals, molded parts for sanitary ware and bathroom fittings, cover grilles for ventilator openings, molded parts for greenhouses and tool sheds, housings for garden tools.

The following examples further illustrate the invention.

### EXAMPLES

The components listed in Table 1 and briefly outlined below were compounded in an internal kneader at ca 220° C. The molded test specimens were produced on an Arburg 270 E injection molding machine at 300° C.

Component A

Linear Polycarbonate based on bisphenol A: Makrolon® 2600, Bayer A G, Leverkusen (Germany)

Component B

Polyethylene terephthalate had an intrinsic viscosity IV of 0.74 cm³/g and an isothermic crystallisation time at 215° C. of ca 4.2 minutes.

The intrinsic viscosity was measured in phenol/o-dichlorobenzene (1:1 parts by weight) at 25° C.

The isothermic crystallisation time of PET was determined by the DSC (differential scanning calorimetry) method using a PERKIN ELMER DSC 7 Differential Scanning Calorimeter (sample ca. 10 mg, perforated Al pan) with the following temperature programme:

1. Heat from 30° C. to 290° C. at 40° C./min,

2.5 min isothermic at 290° C.,

3. cool from 290° C. to 215° C. at 160° C./min,

4.30 min isothermic at 215° C. (crystallisation temperature);

The evaluation software is PE Thermal Analysis 4.00.

Component C

Graft polymer of 40 parts by weight of a copolymer of styrene and acrylonitrile in a ratio of 73:27 to 60 parts by weight of particulate, crosslinked polybutadiene rubber (mean particle diameter d₅₀=0.3 μm), produced by emulsion polymerization.

Component D1

Bisphenol A-bridged oligomeric phosphoric acid ester: Reofos BAAP, commercial product of Great Lakes Chemical Corporation (USA)

Component D2

Triphenyl phospate: Disflamol T P, Bayer A G, Leverkusen (Germany)

Component D3

Resorcinol-bridged oligomeric phosphoric acid ester: CR-733S, commercial product of Daihachi Chemical Industry Co., Ltd. (Japan)

Component E

Blendex® 449: Teflon master batch of 50 wt. % styrene-acrylonitrile copolymer and 50 wt. % PTFE from GE Specialty Chemicals, Bergen op Zoom (the Netherlands)

Component F1

Pentaerythritol tetrastearate (PETS)

Component F2

Phosphite stabiliser

Examination of the Properties of the Molding Compositions According to the Invention

The notched impact strength ak is measured according to ISO 180/1A:

The flammability is determined according to UL Subj. 94 V on bars measuring 127 mm×127 mm×1.5 mm.

The Vicat B thermal form stability is determined according to ISO 306 on bars measuring 80 mm×10 mm×4 mm.

Elongation at break is determined by-the tensile test to ISO 527.

To determine the weld line strength, the impact strength at the weld line of test specimens measuring 170 mm×10 mm×4 mm injected both sides is measured according to ISO 179/1U.

The environmental stress cracking behaviour (ESC behaviour) is tested on bars measuring 80 mm×10 mm×4 mm. The test medium is a mixture of 60 vol. % toluene and 40 vol. % isopropanol. The test specimens are pre-extended using an arc-shaped template and stored in the above test medium at room temperature. The stress cracking behaviour is determined by the maximum pre-extension (εₓ) at which no stress cracking failure (i.e. no fracture) occurs in the test medium within 5 minutes.

All test specimens were produced by injection molding at an increased processing temperature of 300° C.

A summary of the properties of the compositions according to the invention and the test specimens obtained from them is given in Table 1.

TABLE 1

| Components | | A | B |
|---|---|---|---|
| (parts by wt.) | 1 | Reference | Reference |
| A (PC) | 70.0 | 70.0 | 70.0 |
| B (PET) | 7.0 | 7.0 | 7.0 |
| C (ABS) | 9.0 | 9.0 | 9.0 |
| D1 (BDP) | 12.5 | — | — |
| D2 (TPP) | — | 12.5 | — |
| D3 (RDP) | — | — | 12.5 |
| E (PTFE-MB) | 1.0 | 1.0 | 1.0 |
| F1 (PETS) | 0.4 | 0.4 | 0.4 |
| F2 (Stabiliser) | 0.1 | 0.1 | 0.1 |
| Properties | | | |
| aₖ [kJ/m²] | 17 | 17 | 15 |
| aₙ (weld line) | 27 | 27 | 27 |
| [kJ/m²] | | | |
| Vicat B [° C.] | 101 | 84 | 91 |
| Elongation at break [%] | 76 | 3 | 94 |
| UL 94 V@1.5 mm | V 1 | V 1 | V 1 |
| ESC [%] | 3.2 | 2.4 | 1.6 |

The examples show that, surprisingly, the use of bisphenol A-bridged oligomeric phosphdric acid esters as flame-proofing additives in PC/ABS/PET blends produces a marked improvement in environmental stress cracking resistance at high processing temperatures, i.e. extends the processing window. The compositions also have improved thermal form stability whilst retaining good impact strength, weld line strength, elongation at break and flame-resistance.

When using monophosphates (in this case, triphenol phospate) very poor elongation at-break is observed. The environmental stress cracking resistance is reduced far more significantly as the temperature falls, than that of equivalent bisphenol-diphosphate-based compositions.

When using resorcinol-bridged oligomeric phosphoric acid esters, the elongation at break at increased processing temperatures remains at a high level, but this is coupled with a marked reduction in environmental stress cracking resistance.

Although the invention has been described in detail In the foregoing for the purpose of illustration, it is to be understood that such detail is solely for that purpose and that variations may be made therein by those skilled in the art without departing from the spirit and scope of the invention except as it may be limited by the claims.

What is claimed is:

1. A thermoplastic, molding composition comprising
A) 40 to 95 parts by weight of aromatic polycarbonate and/or polyester carbonate,
B) 0.5 to 30 parts by weight of polyalkylene terephthalate,
C) 0.5 to 30 parts by weight of graft polymer,
D) 0.5 to 25 parts by weight of an oligomeric phosphorus compound of formula (I), 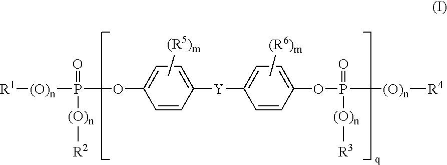
in which
R¹, R², R³, R⁴ independently of each other mean a radical selected from the group consisting of C₁-C₈ alkyl, C₅-C₆-cyclalkyl, C₆-C₁₀ aryl or C₇-C₁₂ aralkyl,
n independently of each other mean 0 or 1,
q 0.5 to 15,
R⁵ and R⁶ independently of each other means C₁-C₄ alkyl radical,
m independently of each other means 0, 1, 2, 3 or 4 and
Y means a member selected from the group consisting of C₁ to C₇ alkylidene, C₁-C₇ alkylene, C₅ to C₁₂ cycloalkylene, C₅ to C₁₂ cycloalklidene radicals, —O—, —S—, —SO₂—, and —CO—, and
E) means 0 to 1 parts by weight of fluorinated polyolefin,
the sum of the parts by weight of A, B, C, D and E being 100.

2. The composition according to claim 1, containing 50 to 90 parts by weight of component A).

3. The composition according to claim 1, containing 1 to 20 parts by weight of polyalkylene terephthalate.

4. The composition according to claim 3, containing 3 to 10 parts by weight of polyalkylene terephthalate.

5. The composition according to claim 1, wherein B) is at least one member selected from the group consisting of polybutylene terephthalate and polyethylene terephthalate.

6. The composition according to claim 1, containing 1 to 20 parts by weight of graft polymer (C).

7. The composition according to claim 1, containing 2 to 18 parts by weight of component D).

8. The corn position according to claim 1, wherein graft polymer C is of C.1, 5 to 95 wt. % of at least one vinyl monomer on C.2, 95 to 5 wt. % of one or more elastomeric grafting bases having a glass transition temperatures <10° C., the wt. % being relative to the weight of the graft polymer.

9. The composition according to claim 8, wherein the graft monomers C.1 includes
C.1.150 to 99 wt. % of at least one monomer from the group of vinyl aromatics, core-substituted vinyl aromatics and methacrylic acid-(C₁-C₈) alkyl esters and
C.1.21 to 50 wt. % of at least one monomer from the group of vinyl cyanidies, (meth)acrylic acid-(C₁-C₈) alkyl esters and unsaturated carboxylic acids,
the wt % being relative to the weight of C.1.

10. The composition according to claim 8, wherein the grafting base is at least one member selected from the group consisting of homopolymeric diene rubbers, copolymeric diene rubbers, EP(D)M rubbers and acrylate rubbers.

11. The composition according to claim 1, wherein q means 1 to 5 and Y means isopropylidene or methylene.

12. The composition according to claim 1, wherein q means 1 to 2 and Y means isopropylidene.

13. The composition according to claim 1, wherein polyalkylene terephthalate, which has an isothermic crystallization <20 min.

14. The composition according to claim 1, further containing at least one member selected from the group consisting of lubricants, mold release agents, nucleation agents, anti-statics, stabilizers, light-protection agents, filling agents, reinforcing agents, dyes, pigments, flame-proofing agents other than component D and flame-proofing synergists.

17. A molded article comprising the composition of claim 1.
